(19) United States
(12) Patent Application Publication
(10) Pub. No.: US 2015/0294358 A1
(43) Pub. Date: Oct. 15, 2015

(54) METHODS AND SYSTEMS FOR DISPLAY OF USER-CUSTOMIZED ADVERTISEMENTS

(71) Applicant: Advisual, Inc., San Francisco, CA (US)

(72) Inventors: Rashed A Wahab Ibrahim Galadari, Westlake Village, CA (US); Noor M. J. I. Badaro, Dubai (AE); Thyagarajapuram S. Ramakrishnan, Saratoga, CA (US); Chintamani Madhav Patwardhan, Saratoga, CA (US)

(21) Appl. No.: 14/684,074

(22) Filed: Apr. 10, 2015

Related U.S. Application Data
(60) Provisional application No. 61/978,748, filed on Apr. 11, 2014.

(51) Int. Cl. G06Q 30/02; G06Q 50/00

(52) U.S. Cl. CPC G06Q 30/0257; G06Q 50/01

(57) ABSTRACT

Disclosed herein are computer-implemented systems and methods for user-customization and display of advertisements via digital media. Generally, the disclosed systems and methods involve a graphical user interface, which allows a user, e.g., a user of a social networking service, to search a database of advertisements, select one or more advertisements of interest, select a format for display of the one or more advertisements of interest, select one/or more customization options for display of the one or more advertisements of interest, and display the one or more advertisements of interest via a digital medium, e.g., a webpage, in accordance with the one or more selections for the one or more customization options.

### CROSS REFERENCE

This application claims the benefit of U.S. Provisional Application No. 61/978,748 filed Apr. 11, 2014, the contents of which are incorporated by reference herein in their entirety.

### INTRODUCTION

The role of targeted advertising, for example based on a user's web browsing history, is quickly expanding in the context of social media applications. However, such tactics often raise privacy concerns with respect to user information and online activity. Given the importance of advertising to content providers and social media platforms, there is a need in the art for improved methods and systems for conveying ads to users in a meaningful way while protecting user privacy.

### SUMMARY

The present disclosure provides computer-implemented systems and methods which involve a user directly in the ad generation, selection, presentation, and/or dissemination process, thereby reducing or eliminating the need for tracking of a user's online activity. In other words, a user is provided with a direct connection to an ad network, via which he or she can actively select ads for viewing. In addition, the user is actively engaged in the ad presentation and/or dissemination process by providing the user with a variety of ad customization options. Disclosed herein are computer-implemented systems and methods for user-customization and display of advertisements via digital media. Generally, the disclosed systems and methods involve a graphical user interface, which allows a user, e.g., a user of a social networking service, to search a database of advertisements, select one or more advertisements of interest, select a format for display of the one or more advertisements of interest, select one/or more customization options for display of the one or more advertisements of interest, and display the one or more advertisements of interest via a digital medium, e.g., a webpage, in accordance with the one or more selections for the one or more customization options.

In some embodiments, the disclosed systems and methods also provide a mechanism for compensation of the user based on one or more of the following: the number of views a digital medium, e.g., a webpage, receives, the number of views the digital medium receives within a given time period, the number of views an advertisement displayed via the digital medium receives, the number of views an advertisement displayed via the digital medium receives in a given time period, the number of click-through events an advertisement displayed via the digital medium receives, the number of click-through events an advertisement displayed via the digital medium receives in a given time period, the number of users linked to the digital medium, and the number of users who access the digital medium in a given time period. Thus, in some embodiments, the present disclosure provides an interactive ad creation/customization environment that allows users of social networking services to select and customize advertisements for display and provides for compensation of the users in connection with same. By actively engaging users in the ad selection process and allowing them to customize ads, improved methods and systems for the delivery of merchant advertisements are provided.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating an embodiment of the present disclosure.

FIG. 2 is a diagram illustrating a detailed embodiment of the present disclosure.

FIG. 3 is diagram illustrating another detailed embodiment of the present disclosure.

FIG. 4 is a diagram of one embodiment of a computer system which may be used to implement one or more of the disclosed systems and/or methods.

### DEFINITIONS

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

“Advertisement” or “ad”: One or more videos, images and/or audio recordings, with or without associated text, used to promote or display a product, service, and/or brand. The terms “advertisement” and “ad,” in the singular or plural, are used interchangeably. The terms “video” and “image” may refer to the actual visual representation or the machine-readable and/or machine-storable medium in which the visual representation is embodied, location identifier(s) of the machine-readable and/or machine-storable medium (e.g., a uniform resource locator (URL)), or any equivalent means to direct a computer-implemented system and/or user to the visual representation. Similarly, the term “audio recording” may refer to the actual audio representation or the machine-readable and/or machine-storable medium in which the audio representation is embodied, location identifier(s) of the machine-readable and/or machine-storable medium (e.g., a uniform resource locator (URL)), or any equivalent means to direct a computer-implemented system and/or user to the audio representation.

“Ad server”: One or more computers, or equivalent systems, which maintains a catalog of advertisements, delivers advertisements, and/or tracks advertisements, campaigns, and/or campaign metrics independent of the platform where the advertisement is being displayed.

“Campaign”: The process or program of planning, creating, buying, and/or tracking an advertising project.

“Merchant”: Seller or provider of a product or service; agent representing a seller or provider; or any third-party charged with preparing and/or providing digital content associated with a product or service. For example, the term merchant should be construed broadly enough to include advertisers, an ad agency, or other intermediaries, charged with developing a digital content to advertise a product or service.

“Digital medium”: This term is used broadly herein to refer to digitized content, such as text, graphics, audio files, video files, and combinations thereof, including, e.g., websites, webpages, desktop and mobile device applications, and the like.

“Webpage”: This term is used broadly herein to encompass, a web document displayed by a web browser on a monitor or mobile device. The term may also be used to refer to a mobile application (or mobile “app”) interface, e.g., as displayed by a mobile device.

### DETAILED DESCRIPTION

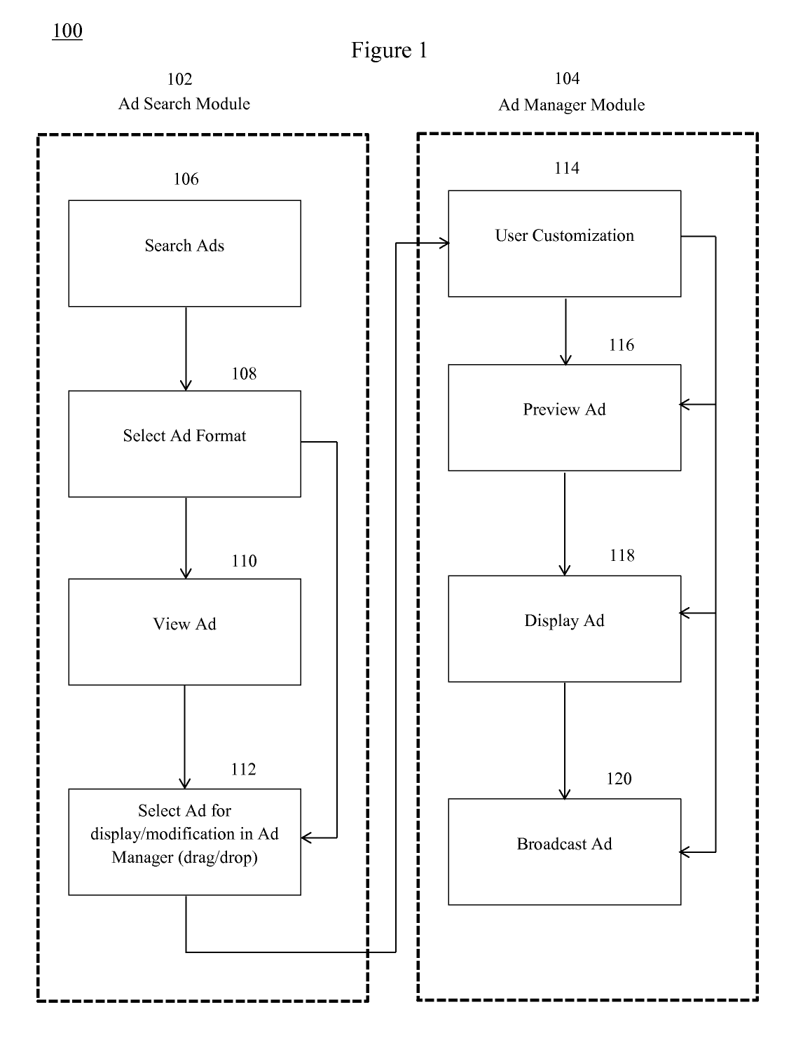

As discussed above, the present disclosure provides computer-implemented systems and methods for user-customization and display of advertisements via digital media, e.g., webpages. The present disclosure can be characterized at least in part as addressing the technical problem of how to accomplish the efficient dissemination of user-selected and/or user-modified media in the context of one or more social media platforms (i.e., one or more social networking services). The present disclosure provides in part a method and system for the display and modification of ads by an end user for further dissemination, which can provide for increased user privacy relative to existing targeted ad distribution methods and systems. For example, with reference to FIG. 1, in some embodiments, the present disclosure provides a system 100 including an ad search module 102 and an ad manager module 104. Utilizing the ad search module 102, a user of the system (e.g., a user of a social networking service) may search ads 106 (e.g., ads provided by 3^{rd} party advertisers) select an ad format 108, optionally view an ad 110, and select an ad 112 for display/modification in the ad manager module of the system. Utilizing the ad manager module 104 of the system, a user of the system may customize one or more selected advertisements 114, optionally preview one or more selected advertisements 116, optionally display one or more selected advertisements 118, and optionally broadcast one or more selected advertisements 120.

In order to facilitate use of the above system, the ad search module 102 may include a graphical user interface, wherein the ad search module 102 provides a user of the system with one or more advertisements. The ad manager module 104, which may also include a graphical user interface, enables the following actions: receiving one or more user-selected advertisements from the ad search module 102, providing the user with a plurality of customization options for display of the one or more user-selected advertisements via a digital medium, e.g., a webpage, receiving one or more user selections for the customization options, and displaying via the digital medium the one or more user-selected advertisements in accordance with the one or more user selections for the customization options.

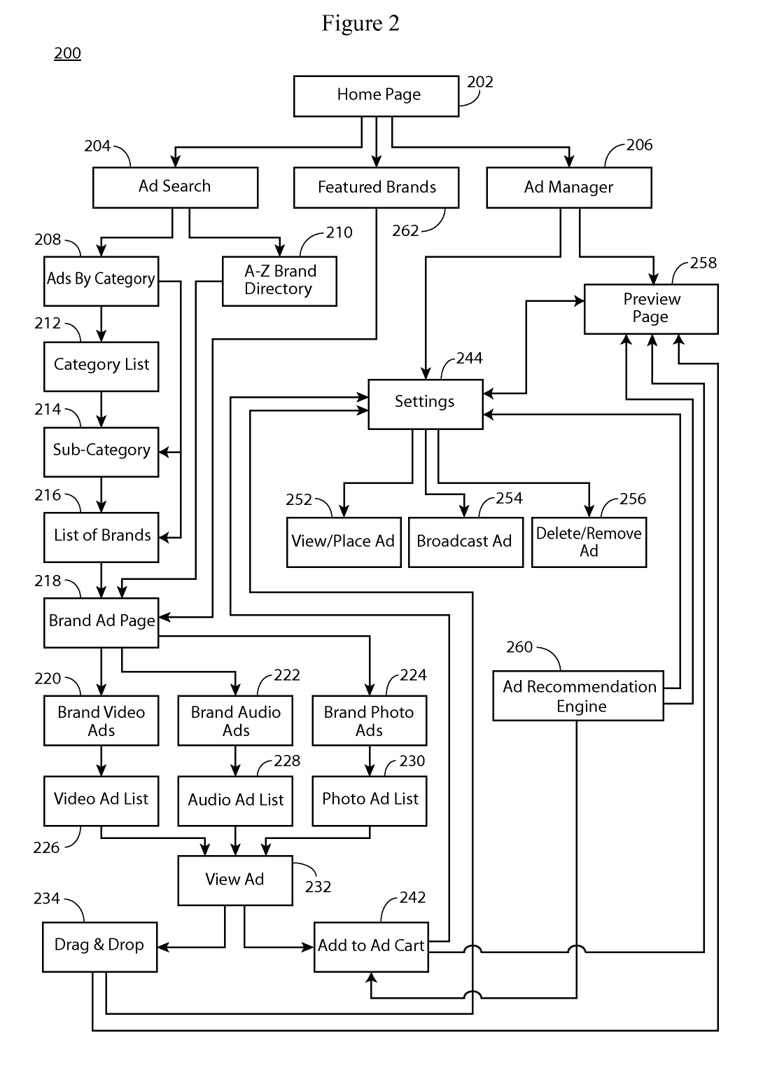

Also provided, with reference to FIG. 2, is a system 200, which may be integrated with a social networking service, e.g., implemented as a component of a social networking service. System 200 includes a homepage 202. From home page 202, a user can access an ad search module 204 and an ad manager module 206. Within ad search module 204, a user may select an ads by category option 208, which may prompt, enable and/or facilitate a user's selection of one or more ad genres, e.g., sports, automotive, entertainment, electronics, food, cosmetics, etc. This may be accomplished, e.g., by providing a graphical user interface including user-selectable ad genre options. Such options may be provided in any suitable manner, e.g., in the form of a category list 212, (e.g., a drop-down list), as one or more menu items, individually selectable icons, etc. From the ads by category option 208 and/or the category list 212, a user may access one or more sub-categories 214, which provide a further breakdown of the ad genres provided by the ads by category option 208. As with the ads by category option 208, these sub-categories 214 may provide user selectable options in any suitable manner, e.g., in the form of a sub-category list, as one or more menu items, individually selectable icons, etc.

By way of example, within the genre “sports”, suitable user-selectable sub-categories may include, e.g., sportswear, sports equipment, sports memorabilia, etc. Within the genre “automotive”, suitable user-selectable sub-categories may include, e.g., new vehicles, used vehicles, concept vehicles, automobile repair, motorcycles, etc. Within the genre “entertainment”, suitable user-selectable sub-categories may include, e.g., movies, concerts, theater, sporting events, etc. Within the genre “electronics”, suitable user-selectable sub-categories may include, e.g., video games, video game systems, computers (e.g., desktop computers, laptop computers, tablet computers, etc.), smart phones, media players, TVs, stereo components, etc. Within the genre “food”, suitable user-selectable sub-categories may include, e.g., fast food, fine dining, cookbooks, etc. Within the genre “cosmetics”, suitable user-selectable sub-categories may include, e.g., makeup, perfumes, hair care products, etc. Many other suitable sub-categories will be readily apparent to one of ordinary skill in the art.

Based on a user selection of one or more genres or subcategories as discussed above, e.g., from the ads by category option 208, the category list 212, or the sub-categories 214, a list of brands 216 is provided, e.g., as a component of a graphical user interface. The list of brands 216, which identifies one or more merchants as described herein which provide a good and/or service falling within the selected genre or subcategory, may be provided in any suitable manner, e.g., in the form of a list (e.g., a drop-down list), as one or more menu items, as individually selectable icons, etc. The one or more merchants may be identified and/or represented by name, logo, Trademark, Service Mark, and/or any other suitable means.

As an alternative (or in addition to) selecting the ads by category option 208, a user may select an A-Z brand directory 210, which provides a list, e.g., an ordered list, of available ads and/or associated brands for user selection. The A-Z brand directory 210 may provide user selectable options in any suitable manner, e.g., as one or more menu items, individually selectable icons, etc. The A-Z brand directory 210 may provide a searchable list of available ads and/or associated brands. The list of available ads and/or associated brands may be provided in alphabetical order, in order by number of available ads, or in any other suitable order.

Once a brand has been selected and/or accessed by the user, e.g., from the list of brands 216 or the A-Z brand directory 210, the user is directed to brand ad page 218, which may be an official account page of a 3^{rd} party advertiser, i.e., merchant, within system 200 or linked to system 200. From brand ad page 218 a user may select a desired ad format by selecting from, e.g., brand video ads 220, brand audio ads 222, and brand photo ads 224, which provide user selectable video, audio and photo ads, respectively, from a particular merchant, i.e., advertiser. In this regard it should be noted that as used herein the term “video ads” include at least one video component, but may also include one or more of audio, graphical and/or textual components. In contrast, the term “audio ad” as used herein refers to an ad which includes at least an audio component, but does not include a video component. An audio ad may also include one or more graphical and/or textual components. As used herein, “photo ads” include at least one photographic component, graphical component, and/or textual component.

From brand video ads 220, brand audio ads 222, and brand photo ads 224, a user may be provided with a list of relevant user-selectable ads in the selected format, e.g., in the form of video ad list 226, audio ad list 228 and/or photo ad list 230, respectively. These “lists” may be provided in any suitable manner, e.g., as one or more menu items, individually selectable icons, thumbnails, etc.

After selecting one or more ads from video ad list 226, audio ad list 228 and/or photo ad list 230, a user may optionally view one or more of the one or more selected ads at view ad option 232.

After selecting and/or viewing one or more ads from video ad list 226, audio ad list 228 and/or photo ad list 230, a user may utilize a drag & drop feature 234 to move, open and/or save one or more selected ads in or to the settings component 244 of ad manager module 206 for customization, publication and/or sharing. This may be accomplished, for example, by using the drag & drop feature 234 to place the one or more selected ads (or a representation thereof) on a representation (e.g., icon) of settings component 244 on a graphical user interface. Drag & drop feature 234 also provides the user with the option to move, open and/or save one or more selected ads in or to the preview page 258 of ad manager 206, which preview page 258 is described in greater detail below.

Within the ad manager module 206, the ad manager settings component 244 allows the user to customize one or more selected ads for display, e.g., by adjusting configurations and/or settings for display of the selected ads. From the ad manager settings component 244, the user can choose to view/place an ad 252, e.g., an ad that has been customized by the user, broadcast an ad 254, or delete/remove an ad 256. The user also has the option to view one or more selected ads on preview page 258, which provides a preview of what the one or more ads will look like when displayed in a desired location, e.g., on any suitable webpage, such as a webpage of a social networking service.

When a user selects the option to view/place an ad 252, the user may view an ad, e.g., an ad that has been customized by the user and/or select an option to place and/or display the ad in a desired location, e.g., on any suitable webpage, such as a webpage of a social networking service. The webpage may be one which is optimized and/or configured for display on either a desktop computer or mobile computing device (e.g., a smart phone, such as an iPhone® or Android® phone, tablet computer, etc.). When displayed on a webpage of a social networking service, a selected ad may be positioned in proximity to, e.g., adjacent to, a user's post and/or update on the webpage. For example, the selected ad may be positioned to the right, to the left, on top of, or on the bottom of, a user's post and/or update on the webpage.

When a user selects the option to broadcast an ad 254, the user may choose to send the ad to one or more of the user's connections; e.g., one or more of the users connections on a social networking service, such as one or more individuals or entities on the user's “friends list” for a social networking service; one or more of the user's e-mail contacts; etc.

As an alternative to moving and/or opening user-selected ads in the ad manager module 206, the user-selected ads may be stored in ad cart 242 for later implementation and/or customization in the ad manager module 206. For example, a user may select one or more ads stored in the ad cart for customization using the ad manager settings component 244.

From home page 202, a user can also access a list of featured brands and/or ads via a featured brands component 262. These featured brands and/or ads may be provided to the user in any suitable manner, e.g., in the form of a list (e.g., a drop-down list), as one or more menu items, as individually selectable icons, etc. When one or more featured brands and or ads are selected by the user, the user is taken to brand ad page 218 as described above, whereby the user can select a desired ad format. The user may then proceed as outlined above.

System 200 may also include an ad recommendation engine 260, which functions to provide the user with one or more recommended ads for possible selection and/or customization. The ad recommendation engine 260 may make recommendations automatically or as prompted by the user. The ad recommendation engine 260 may provide the user with the one or more recommended ads by moving, opening and/or saving the one or more recommended ads to or on settings component 244 and/or preview page 258, which may be accessed from ad manager 206. Alternatively, or in addition, ad recommendation engine 260 may place one or more recommended ads in the user's ad cart 242 for later access by the user.

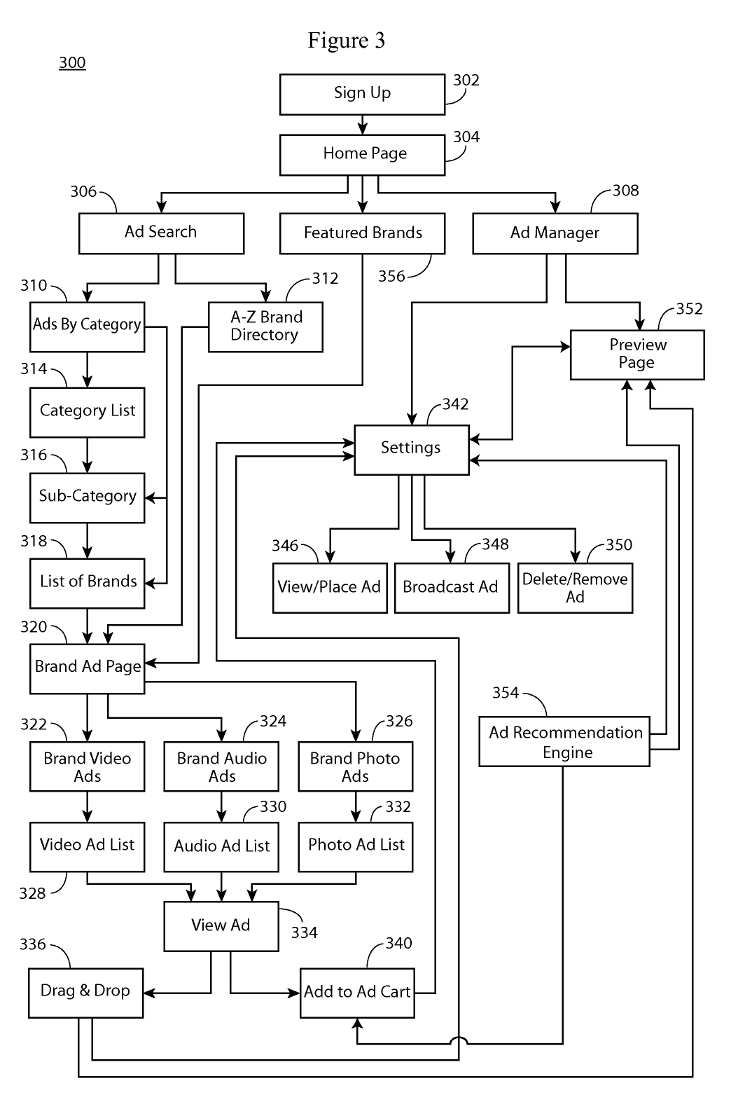

As an alternative to providing an ad customization system as a component of a social networking service, such a system may be provided as a “stand-alone” application and/or system. Such a system may have many similarities to an integrated system such as that described above with reference to FIG. 2. An embodiment of such a “stand-alone” system is now described with reference FIG. 3.

System 300 includes a sign-up page 302, on which a user can register as a user of the system 300. Such registration may require and/or prompt the user to provide identifying information such as name, address, e-mail address, phone number, age, gender, etc. The registration may be provided free of charge or may require the payment of a registration fee, which may be paid, e.g., using a credit card. The registration may be integrated with an external website, e.g., a mobile app, to perform seamless common registration. For example, if the user already has a validated registration with a social networking service, the system may provide “one-click” registration, where by the system is able to contact the social networking service servers on the user's behalf and automatically obtain the user's registration information. Once a user has successfully registered as a user of the system, the user may be provided with or be prompted to create access credentials, e.g., a user name and/or password. In some embodiments, as part of the registration process, the user may also be prompted to answer a variety of questions, e.g., to determine interests of the user. Such information may then be utilized by other components of the system as discussed in greater detail below. System 300 includes a homepage 304. From home page 304, a user can access an ad search module 306 and an ad manager module 308. Within ad search module 306, a user may select an ads by category option 310, which may prompt, enable and/or facilitate a user's selection of one or more ad genres, e.g., sports, automotive, entertainment, electronics, food, cosmetics, etc. This may be accomplished, e.g., by providing a graphical user interface including user-selectable ad genre options. Such options may be provided in any suitable manner, e.g., in the form of a category list 314, (e.g., a drop-down list), as one or more menu items, individually selectable icons, etc. From the ads by category option 310 and/or the category list 314, a user may access one or more sub-categories 316, which provide a further breakdown of the ad genres provided by the ads by category option 310. As with the ads by category option 310, these sub-categories 316 may provide user selectable options in any suitable manner, e.g., in the form of a sub-category list, as one or more menu items, individually selectable icons, etc. Suitable user-selectable sub-categories may be similar to those described above for system 200.

Based on a user selection of one or more genres or subcategories as discussed above, e.g., from the ads by category option 310, the category list 314, or the sub-categories 316, a list of brands 318 is provided, e.g., as a component of a graphical user interface. The list of brands 318, which identifies one or more merchants as described herein which provide a good and/or service falling within the selected genre or subcategory, may be provided in any suitable manner, e.g., in the form of a list (e.g., a drop-down list), as one or more menu items, as individually selectable icons, etc. The one or more merchants may be identified and/or represented by name, logo, Trademark, Service Mark, and/or any other suitable means.

As an alternative (or in addition to) selecting the ads by category option 310, a user may select an A-Z brand directory 312, which provides a list, e.g., an ordered list, of available ads and/or associated brands for user selection. The A-Z brand directory 312 may provide user selectable options in any suitable manner, e.g., as one or more menu items, individually selectable icons, etc. The A-Z brand directory 312 may provide a searchable list of available ads and/or associated brands. The list of available ads and/or associated brands may be provided in alphabetical order, in order by number of available ads, or in any other suitable order.

Once a brand has been selected and/or accessed by the user, e.g., from the list of brands 318 or the A-Z brand directory 312, the user is directed to brand ad page 320, which may be an official account page of a 3^{rd} party advertiser, i.e., merchant, within system 300 or linked to system 300. From brand ad page 320 a user may select a desired ad format by selecting from, e.g., brand video ads 322, brand audio ads 324, and brand photo ads 326, which provide user selectable video, audio and photo ads, respectively, from a particular merchant, i.e., advertiser.

From brand video ads 322, brand audio ads 324, and brand photo ads 326, a user may be provided with a list of relevant user-selectable ads in the selected format, e.g., in the form of video ad list 328, audio ad list 330 and/or photo ad list 332, respectively. These “lists” may be provided in any suitable manner, e.g., as one or more menu items, individually selectable icons, thumbnails, etc.

After selecting one or more ads from video ad list 328, audio ad list 330 and/or photo ad list 332, a user may optionally view one or more of the one or more selected ads at view ad option 334.

After selecting and/or viewing one or more ads from video ad list 328, audio ad list 330 and/or photo ad list 334, a user may utilize a drag & drop feature 336 to move, open and/or save one or more selected ads in or to the ad manager module 308 for customization, publication and/or sharing. This may be accomplished, for example, by using the drag & drop feature 336 to place the one or more selected ads (or a representation thereof) on a representation (e.g., icon) of settings component 342 on a graphical user interface. Drag & drop feature 336 also provides the user with the option to move, open and/or save one or more selected ads in or to the preview page 352 of ad manager 308, which preview page 352 is described in greater detail below.

Within the ad manager module 308, the ad manager settings component 342 allows the user to customize one or more selected ads for display, e.g., by adjusting configurations and/or settings for display of the selected ads. From the ad manager settings component 342, the user can choose to view/place an ad 346, e.g., an ad that has been customized by the user, broadcast an ad 348, or delete/remove an ad 350. The user also has the option to view one or more selected ads on preview page 352, which provides a preview of what the one or more ads will look like when placed in a desired location, e.g., on any suitable webpage, such as a webpage of a social networking service.

When a user selects the option to view/place an ad 346, the use may view an ad, e.g., an ad that has been customized by the user and/or select an option to place and/or display the ad in a desired location, e.g., on any suitable webpage, such as a webpage of a social networking service. The webpage may be one which is optimized and/or configured for display on either a desktop computer or mobile computing device (e.g., a smart phone, such as an iPhone® or Android® phone, tablet computer, etc.). When displayed on a webpage of a social networking service, a selected ad may be positioned in proximity to, e.g., adjacent to, a user's post and/or update on the webpage. For example, the selected ad may be positioned to the right, to the left, on top of, or on the bottom of, a user's post and/or update on the webpage.

When a user selects the option to broadcast an ad 348, the user may choose to send the ad to one or more of the user's connections; e.g., one or more of the users connections on a social networking service, such as one or more individuals or entities on the user's “friends list” for a social networking service; one or more of the user's e-mail contacts; etc.

As an alternative to moving and/or opening user-selected ads to or in the ad manager module 308, the user-selected ads may be stored in ad cart 340 for later implementation in the ad manager module 308. For example, a user may select one or more ads stored in the ad cart for customization using the ad manager settings component 342.

From home page 304, a user can also access a list of featured brands and/or ads via a featured brands component 356. These featured brands and/or ads may be provided to the user in any suitable manner, e.g., in the form of a list (e.g., a drop-down list), as one or more menu items, as individually selectable icons, etc. When one or more featured brands and or ads are selected by the user, the user is taken to brand ad page 320 as described above, whereby the user can select a desired ad format. The user may then proceed as outlined above.

System 300 may also include an ad recommendation engine 354, which functions to provide the user with one or more recommended ads for possible selection and/or customization. The ad recommendation engine 354 may make recommendations automatically or as prompted by the user. The ad recommendation engine 354 may provide the user with the one or more recommended ads by moving, opening and/or saving the one or more recommended ads to or on preview page 352, which may be accessed from ad manager 308. Alternatively, or in addition, ad recommendation engine 260 may place one or more recommended ads in the user's ad cart 340 for later access by the user.

### Methods and Systems

In addition to the detailed system embodiments described above with reference to the figures, the present disclosure provides a variety of related methods and systems which allow for user selection and customization of advertisements for display via a digital medium, e.g., a webpage. For example, in some embodiments, a method is provided which includes the following steps, one or more of which are performed using one or more computer processors: searching a database of advertisements; selecting for display via a digital medium one or more of the advertisements based on a result of the searching step; selecting a format for the display of the one or more advertisements selected for display via the digital medium; viewing a plurality of customization options for display of the one or more advertisements selected for display via the digital medium; selecting one or more of the customization options for display of the one or more advertisements selected for display via the digital medium; and viewing the one or more advertisements selected for display via the digital medium in accordance with the one or more selections for the one or more customization options. The digital medium may include a webpage, on which the one or more advertisements selected for display in accordance with the one or more selections for the one or more customization options are displayed for viewing.

Also provided is a method for providing user-customized advertisements via a digital medium, e.g., a webpage, wherein the method includes the following steps, one or more of which are performed using one or more computer processors: providing a user with a plurality of advertisements; identifying one or more advertisements selected by the user for display via the digital medium; providing the user with a plurality of customization options for the display of the one or more advertisements selected by the user for display via the digital medium; receiving one or more user selections for the customization options; and displaying via the digital medium the one or more advertisements selected by the user for display via the digital medium in accordance with the one or more user selections for the customization options. The digital medium may include a webpage, on which the one or more advertisements selected for display in accordance with the one or more selections for the one or more customization options are displayed for viewing.

Also provided is a system for providing user-customized advertisements via a digital medium, e.g., a webpage, the system including: an advertisement database; a user device displaying a digital medium; one or more computer processors; and a graphical user interface, wherein the graphical user interface provides for selection by the user of one or more advertisements from the advertisement database to be displayed via the digital medium, and provides the user with a plurality of customization options for the display of the one or more advertisements via the digital medium, and wherein one or more of the one or more processors receives one or more user selections for the customization options and displays via the digital medium the one or more advertisements selected by the user for display via the digital medium in accordance with the one or more user selections for the customization options. The digital medium may include a webpage, on which the one or more advertisements selected for display in accordance with the one or more selections for the one or more customization options are displayed for viewing.

Also provided is a system including: an ad search module including a graphical user interface, wherein the ad search module provides a user of the system with one or more advertisements; and an ad manager module comprising a graphical user interface, wherein the ad manager module: receives one or more user-selected advertisements from the ad search module; provides the user with a plurality of customization options for display of the one or more user-selected advertisements via a digital medium, e.g., a webpage; receives one or more user selections for the customization options; and displays via the digital medium the one or more user-selected advertisements in accordance with the one or more user selections for the customization options.

The above methods and systems may be implemented, for example, using a system 100, 200 or 300 as described herein.

The digital medium of the methods and systems described herein may include a webpage, for example, a user profile page, a blog page, a webpage of a business entity, or a webpage of a non-profit organization. In some embodiments, the user profile page is a user profile page of a social networking service, e.g., a user profile page of a website of a social networking service. Once the user has registered with the system and selected one or more advertisements, brands or categories, the stand-alone system may serve as an “ad network” to other websites, e.g., mobile applications, wherein when the user visits these websites and/or uses the mobile apps, the system may integrate with the systems of these websites and/or mobile apps to display ads to the user based on their preferences.

In addition, when the user selects one or more ads, brands or categories, the system may display ads containing news, information, images and other content related to the ads, brands or categories. These items may be displayed on websites, e.g., mobile apps, in the same place and manner in which an advertisement may be displayed. For example, in some embodiments non-ad content may be displayed within an advertisement window to be displayed via a digital medium, e.g., along with an ad.

Also, periodically, the system may insert a query instead of the advertisement, prompting the user to either re-confirm their advertisement, brand or category selections or choose new ones. For example, the question may be of the form: “Are you still interested in brand XYZ” (Yes/No). If the user selects “Yes”, the panel is replaced with a suitable advertisement. If the user selects “No”, the user may be directed to the Home Page to select other advertisements, brands or categories of their interest.

Customization Options

As discussed above, the methods and systems described herein may involve selecting one or more customization options for display of one or more advertisements via a digital medium, providing a user with a plurality of customization options for the display of one or more advertisements via a digital medium, and/or receiving one or more user selections for the customization options. Such customization options may include a selectable location, size and/or shape of an advertisement window on which an advertisement is to be displayed via the digital medium, e.g., on a webpage, wherein an advertisement of the one or more advertisements is positioned, sized and/or shaped to fit a selected location, size and/or shape of the advertisement window upon display of the one or more advertisements via the digital medium. Other customization options which may be selected and/or adjusted by a user include photo filter effects and/or backgrounds which include an advertiser's logo and/or brand name. Such photo filter effects and/or backgrounds may be downloaded by a user as a tool for ad customization and may be used in connection with video, audio or photo ads. Such photo filter effects and/or backgrounds may also include one or more hyperlinks, which, when activated by a user, direct the user to a website or webpage of the advertiser.

Other user-customization options include the selection of a dynamic or static display of one or more advertisements. For example, when displayed dynamically, advertisements may be displayed as actively scrolling across a display area, e.g., from right to left, left to right, top to bottom, or bottom to top, e.g., upon opening of a webpage on which the advertisement is provided.

Other user-customization options include adjustment of the duration and/or frequency of display of one or more advertisements via a digital medium, e.g., on a webpage. For example, the user may select or be provided with an option to select a display period of one day, one week, one month, etc. Alternatively, or in addition, the display frequency may be customized. For example, a user may select a setting such that the advertisement is only displayed the first time or every other time a user accesses the webpage. In some embodiments, the advertisers themselves may set the duration and/or frequency of display of the advertisement on the webpage. For example, an advertiser may set their ads to expire after one day, one week, etc. Alternatively, or in addition, an advertiser may set their ads to expire following expiration of a preset display frequency, e.g., after a user has viewed the displayed ad one, two, three, four, five, or more times.

User customization options may also include an option to select a mobile device display configuration or a non-mobile device display configuration. Where a mobile device display configuration is selected, the ad may be one which is configured and/or optimized for viewing on a mobile device, e.g., a smart phone, tablet, etc.

User Compensation and Badging

The disclosed methods and systems may include a step or mechanism for providing compensation to a user or receiving compensation as a user. For example, such compensation may be provided or received based on one or more of the following: the number of views a digital medium (e.g., a webpage) receives, the number of views the digital medium receives within a given time period, the number of views an advertisement displayed via the digital medium receives, the number of views an advertisement displayed via the digital medium receives in a given time period, the number of click-through events an advertisement displayed via the digital medium receives, the number of click-through events an advertisement displayed via the digital medium receives in a given time period, the number of users linked to the digital medium, and the number of users who access the digital medium in a given time period.

The compensation provided to or received by the user may be monetary compensation or may take the form of one or more credits, coupons, discounts, promotions, raffles or special offers. In some embodiments, the compensation provided to or received by the user may be digital monetary compensation, e.g., BitCoin™ (or other peer-to-peer payment system) or any similar form of digital currency. In some embodiments, the user may receive a ranking from one or more merchants based on his or her activity (e.g., as described in greater detail below). In connection with the disclosed methods and systems, a user may elect to receive, not receive, or donate to charity compensation earned as discussed above.

When a user elects to donate to charity or not receive compensation earned as discussed above, the user may be provided via the methods and systems described herein with a badge, e.g., an emblem or other identifier which identifies the user as one who has donated to charity or elected to not receive compensation, which may be displayed, for example, on a webpage, e.g., on the user's profile page of a social networking website. In this regard, the badge may be one which signifies the degree or level of charitable contribution (or compensation not received) the user has achieved, e.g., based on the amount of earned compensation contributed or not received. In some embodiments, the methods and systems may provide for the collection by the user of multiple badges, with different badges being assigned to different thresholds of charitable contribution or forgone compensation.

These features of the disclosed methods and systems provide for an interactive ad creation environment that allows users of websites, e.g.: social networking sites, to select and customize advertisements for display and provides for monetary compensation and non-monetary compensatory reward to the users in connection with the same. By actively engaging users in the ad selection process and ad creation process (e.g., by allowing them to customize ads), improved methods and systems for the delivery of merchant advertisements are provided.

Ad Recommendation

The methods and systems of the present disclosure may include steps and/or components, e.g., ad recommendation engines (such as ad recommendation engines 260 and 354) and/or ad feeds, which facilitate the provision to or receipt by the user of recommended advertisements, which the user may then view, customize and/or cause to be displayed in a desired location, e.g., on a webpage of a social networking service. Such recommendations may be based on the user's prior selection of advertisements, brands or categories and/or the user's prior selections for the customization options. For example, the recommended advertisements may be based on an analysis of the user's history, e.g., complete history of prior selections of advertisements and/or prior selections for the customization options.

Recommended advertisements may also be provided based on the subject matter or content of the user's posts and/or media uploads to (and/or downloads from) a social networking service. For example, recommended advertisements may include advertisements which include subject matter or content in common with or related to the user's posts and/or media uploads to (and/or downloads from) a social networking service. Such subject matter or content may be identified, e.g., through the use of one or more of the following analysis methods and/or utilities known in the art: image recognition software, keyword identification and matching methods and/or utilities, and metadata analysis methods and/or utilities.

A user may also select one or more subject matter categories, brands, companies, or organizations from which he or she wishes to receive ad recommendations. Accordingly, the user may elect to “follow”, “watch” or “subscribe” to receive ads in a particular subject matter category or from a particular brand, company, or organization. Such ads may be provided to a user by an ad recommendation engine as discussed herein. Alternatively, or in addition, such ads may be provided in an ad feed which may be displayed for viewing by the user, e.g., on a webpage of a social networking service, e.g., on a user's profile page of a social networking service. When provided in an ad feed, such advertisements may be displayed in a variety of formats, e.g., as thumbnail versions of the ads which are displayed statically or dynamically. When displayed dynamically, such thumbnails may be displayed as actively scrolling across a display area, e.g., from right to left, left to right, top to bottom, or bottom to top, e.g., upon opening of a webpage on which the ad feed is provided.

Recommended advertisements may also be provided to the user based on one or more advertisements posted by one or more of the user's network connections, e.g., one or more of the user's networking connections on a social networking service, e.g., one or more of the user's “associates”, “contacts” or “friends” on a social networking service. Similarly, recommended advertisements may be provided based on one or more advertisements posted by one or more second users from whom a first user receives regular or intermittent updates via a social networking service, e.g., one or more second users “followed” or “watched” by the first user via a social networking service.

In addition, or alternatively, recommended advertisements may be provided to the user based on the subject matter or content of one or more posts and/or updates, which may include, e.g., text and/or photos, by one or more of the user's network connections, e.g., one or more of the user's networking connections on a social networking service, e.g., one or more of the user's “associates”, “contacts” or “friends” on a social networking service. Similarly, recommended advertisements may be provided based on the subject matter or content of one or more posts and/or updates made by one or more second users from whom a first user receives regular or intermittent updates via a social networking service, e.g., one or more second users “followed” or “watched” by the first user via a social networking service. As discussed above, such subject matter or content may be identified, e.g., through the use of one or more of the following analysis methods and/or utilities known in the art: image recognition software, keyword identification and matching methods and/or utilities, and metadata analysis methods and/or utilities.

Alternatively, or in addition, ads may be recommended to the user based on the activity of the user or one or more of the user's connections on a social networking service, e.g., a social networking site into which one or more of the disclosed systems has been integrated. For example, one or more ads may be recommended to the user based on one or more photo tags found on the webpage where the ads will be displayed, e.g., one or more ads having the same or related content or subject matter as the one or more photo tags. Alternatively, or in addition, one or more ads may also be recommended to the user, wherein such ads are associated with (e.g., contain the same or related content or subject matter) as media uploaded, downloaded, and/or viewed by the user. In some embodiments, the ad recommendation may utilize information provided by the user as part of a registration process as described above. For example, an ad recommendation engine or ad feed may adjust its recommendations based on the gender, age or geographic location of the user. Alternatively, in some embodiments, no activity of the user or the user's connections is taken into consideration other than activity of the user and/or the user's connections in selecting, customizing and/or disseminating one or more ads as described herein. For example, in some embodiments the disclosed methods do not involve the tracking of a user's internet browser search history.

In response to the receipt of a recommended advertisement, the user may view, accept, reject, modify or share the recommended advertisements. The user may then receive additional recommended advertisements based at least in part on the user's prior acceptance, rejection, modification or sharing of previously recommended advertisements. This iterative process may continue thereby enabling the provision of ad recommendations personally tailored to the preferences of the user.

While the above ad recommendation methods and related systems are described in the context of ads, it should be noted that non-ad content may also be provided to the user via the ad recommendation methods and systems described above and elsewhere herein. For example, a user may be provided with news, information, images and other content related to the ads, brands or categories (e.g., related to the subject matter of the ads brands or categories) previously selected by the user and/or related to the user's prior selections for the customization options.

Connection Recommendation

As discussed herein, when a user selects an option to broadcast an ad in connection with the disclosed methods and systems, the user may choose to send the ad to one or more of the user's connections; e.g., one or more of the users connections on a social networking service, such as one or more individuals or entities on the user's “friends list” for a social networking service; one or more of the user's e-mail contacts; etc. In order to facilitate this process, the disclosed systems and methods may include a connection recommendation module which functions to provide the user with recommended recipients for one or more ads selected by the user. The recommendation module may recommend one or more recipients for one or more ads from a pool of potential recipients based on a variety of factors. For example, the recommendation module may recommend one or more recipients for one or more ads based on the subject matter and/or content of the one or more ads; the subject matter and/or content of one or more of the user's posts or media uploads or downloads on a social networking service, e.g., on a webpage of a social networking service; the subject matter and/or content of one or more of the potential recipients posts or media uploads or downloads on a social networking service, e.g., on a webpage of a social networking service; and any combination thereof. For example, the recommendation module may recommend one or more recipients for one or more ads from a pool of potential recipients based on the presence of similar or common subject matter and/or content in the one or more ads and the posts or media uploads or downloads of the potential recipients on a social networking service. Such subject matter and/or content may be identified, e.g., through the use of one or more of the following analysis methods and/or utilities known in the art: image recognition software, keyword identification and matching methods and/or utilities, and metadata analysis methods and/or utilities.

Upon identifying one or more recommended recipients, the connection recommendation module may automatically send one or more user-selected ads to the one or more recommended recipients, e.g., such that the one or more user-selected ads are displayed for viewing by the one or more recommended recipients, e.g., on a web feed or webpage of a social networking service. Alternatively, or in addition, the connection recommendation module may provide a user with the option to select one or more recommended recipients to receive a selected ad for viewing.

Replacement Ads and Ad Queue

The disclosed systems and methods may include components and/or steps to facilitate storage of ads selected by the user prior to customization and/or display of such ads. In addition, or alternatively, the disclosed systems and methods may include components and/or steps which facilitate the replacement of one or more user-selected ads, e.g., automatically following expiration of one or more user selected ads. Ad cart 242 or ad cart 340 of systems 200 and 300 respectively may be used for the storage of user selected ads. The systems and methods may also provide an ad queue including replacement advertisements which may be provided to, or received by, the user. In some embodiments the ad queue may be a component of an ad cart as described herein. In other embodiments, the ad queue may be provided as a separate component. Replacement ads may be provided to or received by the user at expiration, e.g., following a predetermined time period and/or number of click-through events, or removal, of one or more advertisements selected for display on the webpage. The ad queue may also function to automatically replace one or more user selected ads following expiration as described above. The ad queue may be populated with ads by the user or automatically by the systems and methods of the present disclosure. Where the ad queue is populated automatically, it may do so without any user intervention. Alternatively, the user may select that the ad queue be populated automatically based on certain user-selected criteria, e.g., the user may select that the ad queue be populated automatically by ad category or brand. The user may also choose to be notified when an ad they selected has expired, thereby enabling them to replace the ad by manually selecting an alternative ad.

Geographical Location

In some embodiments of the present disclosure, the methods and systems described herein contain a geographical location component. For example, in the context of a system 100, a system 200, a system 300 or any of the systems and/or methods described herein, the ads available for selection and/or the ads available for recommendation may be limited by the geographical location of the merchant, e.g., advertiser. Similarly, the ads available for selection and/or the ads available for recommendation may be limited by the geographical location of the user. Thus, for example, where the user is located in San Francisco, Calif., the ads available for selection and/or the ads available for recommendation may be limited to ads for products and/or services provided by merchants located in San Francisco, Calif. In some embodiments, the ads available for selection and/or the ads available for recommendation may be limited to ads for products and/or services provided by merchants located within a specified geographical region, e.g., a city or state; or within a specified, distance of the user's location, e.g., within about a 100 mile radius of the user's location, within about a 50 mile radius of the user's location, within about a 40 mile radius of the user's location, within about a 30 mile radius of the user's location, within about a 20 mile radius of the user's location, within about a 10 mile radius of the user's location, within about a 5 mile radius of the user's location, or within about a 1 mile radius of the user's location.

Merchant Size

In some embodiments of the present disclosure, the methods and systems described herein contain a merchant size component. For example, in the context of a system 100, a system 200, a system 300 or any of the systems and/or methods described herein, the ads available for selection and/or the ads available for recommendation may be limited by the size of the merchant, e.g., advertiser, whose products and/or services are advertised in the ads. The size of the merchant, e.g., advertiser, may be determined by, e.g., one or more of: the number employees of the merchant, the number of “brick and mortar” locations of the merchant, the annual sales of the merchant, and any other suitable criteria. For example, in some embodiments, the ads available for selection and/or the ads available for recommendation may be limited to ads for goods and/or services of merchants which are characterized as small businesses. A merchant may be characterized as a small business if, e.g., the merchant has between about 1 and about 100 employees, e.g., between about 1 and about 75 employees, between about 1 and about 50 employees, between about 1 and about 40 employees, between about 1 and about 30 employees, between about 1 and about 20 employees, between about 1 and about 10 employees, or between about 1 and about 5 employees. In addition, or alternatively, a merchant may be characterized as a small business if the merchant has between about 1 and about 50 brick and mortar locations, e.g., between about 1 and about 25 brick and mortar locations, between about 1 and about 20 brick and mortar locations, between about 1 and about 15 brick and mortar locations, between about 1 and about 10 brick and mortar locations, between about 1 and about 5 brick and mortar locations, or 1 brick and mortar location. Alternatively, or in addition, a merchant may be characterized as a small business if it has been assigned a small business identification or registration number by the state and/or city in which it is located.

Small Business Portal

In some embodiments, the present disclosure provides systems and methods, e.g., systems and methods as described previously herein, wherein a merchant, e.g., a merchant which may be characterized as a small business as described herein, may contribute to a pool of ads available for selection by and/or recommendation to a user according to the methods and systems described herein. In some embodiments, the merchant is provided with the option of selecting a particular user or group of users which will have the ability to select, and/or receive as recommended, one or more ads for products and/or services of the merchant. A particular user or group of users may be selected as having the ability to select, and/or receive as recommended, one or more ads for products and/or services of the merchant based on a variety of criteria. For example, in some embodiments, a merchant may select a particular user or group of users as having the ability to select, and/or receive as recommended, one or more ads for products and/or services of the merchant based on the geographical location of the user, the number of connections the particular user or groups of users has to other users of a social networking service, e.g., the number of “friends” the particular user or group of users has on the social networking service, the geographical location of the user's connections, and any combination thereof.

In some embodiments, a merchant may select a particular user or group of users as having the ability to select, and/or receive as recommended, one or more ads for products and/or services of the merchant based on, e.g., the number of views a user's webpage (e.g., a user's profile page on a social networking service) receives, the number of views a user's webpage receives within a given time period, the number of click-through events an advertisement displayed on the user's webpage receives, the number of click-through events an advertisement displayed on the webpage receives in a given time period, the number of users linked to the webpage, and/or the number of users who access the webpage in a given time period.

One or more of the above criteria may be used or combined to assign a relevancy ranking for the user or group of users with respect to a particular merchant. For example, a user located in the same geographical area as the merchant who regularly posts or comments about products or services in the same general category as those of the merchant may be assigned a relatively higher relevancy ranking than a user in a different geographical location who rarely posts or comments about products or services in the same general category as those of the merchant. As another example, between a first and second user who both regularly post or comment about products or services in the same general category as those of the merchant, the user with a greater number of network connections on a social networking service may be given a relatively higher relevancy ranking. A merchant can weigh these rankings when determine which users or users will have the ability to select, and/or receive as recommended, one or more ads for products and/or services of the merchant.

In some embodiments, a merchant may select a particular user or group of users as having the ability to select, and/or receive as recommended, one or more ads for products and/or services of the merchant based on a demonstrated interest of the user or group of users in the general product type or service category of the merchant's products and/or services. For example, a merchant may select a particular user or group of users as having the ability to select, and/or receive as recommended, one or more ads for products and/or services of the merchant based on the subject matter and/or content of one or more of the user's or group of users' posts or media uploads or downloads on a social networking service, e.g., on a webpage of a social networking service. Such subject matter or content may be identified, e.g., through the use of one or more of the following analysis methods and/or utilities known in the art: image recognition software, keyword identification and matching methods and/or utilities, and metadata analysis methods and/or utilities. For example, an owner of a local coffee shop may be interested in selecting a particular user as having the ability to select, and/or receive as recommended, one or more ads for the coffee shop, where the user lives in the same city as the coffee shop and regularly posts about his or her favorite coffee and/or coffee shops.

In some embodiments, a merchant, e.g., a merchant which may be characterized as a small business as described herein, may access one or more of the systems or utilize one or more of the methods described herein through a mobile application or “App” which provides a user-interface directed to the merchant. Such an App may provide ad design functionality and/or ad upload functionality allowing the merchant to create and/or upload one or more advertisements for its products and/or services, e.g., to one or more systems as described herein. In some embodiments, a merchant may select via the App a particular user or group of users as having the ability to select, and/or receive as recommended, one or more ads for products and/or services of the merchant.

Such an App may also provide for the display of various metrics associated with the performance of one or more users with respect to a particular ad or group of ads. Such metrics may include one or more of, e.g., the number of views a user's webpage (e.g., a user's profile page on a social networking service) displaying the ad receives, the number of views a user's webpage displaying the ad receives within a given time period, the number of click-through events the advertisement displayed on the user's webpage receives, the number of click-through events the advertisement displayed on the webpage receives in a given time period, the number of users that receive the ad from the user, the number of users that view the ad, the number of users linked to the webpage displaying the ad, and the number of users who access the webpage displaying the ad in a given time period. Such metrics may be updated in real time; on a periodic basis, e.g., once a day, once a week, etc.; or at any other suitable frequency. In this way, a merchant can assess the performance level of a particular user or groups of users with respect to a particular ad or group of ads.

Such metrics may also be displayed to a user using an App which provides a graphical user interface directed to the user. In this way, a user can monitor his or her performance with respect to an ad or ads. A user may also utilize such an App to show or demonstrate to a merchant that he or she has demonstrated good performance metrics with respect to prior ads and would therefore be a good candidate to facilitate ad dissemination. In some embodiments, such a user App also provides for the upload of user metrics, e.g., for viewing by one or more merchants.

The disclosed systems and methods of the present disclosure may include the assignment of a ranking to a user based on one or more ad-specific performance metrics as discussed above and/or one or more additional criteria as discussed herein, e.g., the number of views a user's webpage (e.g., a user's profile page on a social networking service) receives, the number of views a user's webpage receives within a given time period, the number of users linked to the webpage, and/or the number of users who access the webpage in a given time period. This ranking may be used as the basis for activating, unlocking or selectively enabling certain capabilities of the user in the context of the disclosed systems and methods. By way of example, a user may be assigned a ranking of “Basic User”, “Intermediate User”, or “Premium User” based on an assessment of one or more of the above criteria. Thus, by way of example and not limitation, a user who receives between about 0 and about 10 webpage views per day may be assigned a ranking of “Basic User”, a user who receives between about 10 and about 100 webpage views per day may be assigned a ranking of “Intermediate User”, and a user who receives above about 100 webpage views per day may be assigned a ranking of “Premium User.” These rankings may in turn activate, unlock or selectively enable certain capabilities of the user, such as the ability to broadcast ads to one or more of the user's network connections. Such ranking may also be utilized to activate, unlock, or selectively enable levels or degrees of certain capabilities. Thus, for example, a “Basic User” may have no ability to broadcast ads, an “Intermediate User” may have the ability to broadcast between about 1 and about 5 ads per day, and a “Premium User” may have the ability to broadcast between about 5 and about 10 ads or more per day. It should be noted that any suitable upper limit may be placed on a user's ability to broadcast ads.

In some embodiments, the systems and methods of the present disclosure provide for the connection of a merchant with one or more users as candidates to receive one or more ads of the merchant. The systems and methods of the present disclosure may, in addition or alternatively, provide for the connection of one or more users with one or more merchants as candidate merchants to provide one or more ads to the one or more users. Suggested connections may be provided to the user and/or merchant respectively based on, e.g., a shared location or geographical area of the user and merchant, a demonstrated interest by the user in the general product type or service category of the merchant's products and/or services, e.g., as evidenced by the subject matter and/or content of the user's posts and/or media uploads/downloads, etc. Suggested connections may be provided in a clickable icon format, such that the user and/or merchant can accept the connection, e.g., subject to any applicable terms, via a single click.

The financial relationship between the user, merchant, and the provider of the facilitating system and/or method may be structured in any suitable manner. For example, a merchant may pay a flat, monthly (or any other suitable interval) fee to the provider of the facilitating system and/or method based on the number of users which it selects to receive one or more ads of the merchant. The user may in turn receive a percentage of such fee for their services in connection with disseminating the ad or ads, e.g., by displaying the ad on the user's webpage; sending or broadcasting the ad to one or more of the user's network connections; etc. Alternatively, or in addition, the user may receive a percentage of, e.g., increased sales attributable to the user's activities. Such sales may be identified, e.g., by identifying a purchase that originates from, e.g., a click-through event on the user's webpage or as a result of an ad or link sent by the user to one or more of the user's network connections.

These systems and methods facilitate a digital “grass-roots” advertising scheme with the potential to benefit both the user, in terms of compensation, and the merchant, in the form of targeted, local advertising with a high likelihood of reaching interested customers. In some embodiments, a user may elect to receive, not receive, or donate to charity compensation earned as discussed above. When a user elects to donate to charity or not receive compensation earned as discussed above, the user may be provided via the methods and systems described herein with one or more forms of non-monetary compensation as described herein, e.g., one or more forms of badging as described herein.

### Communication Between Components/Parties Practicing the Present Invention

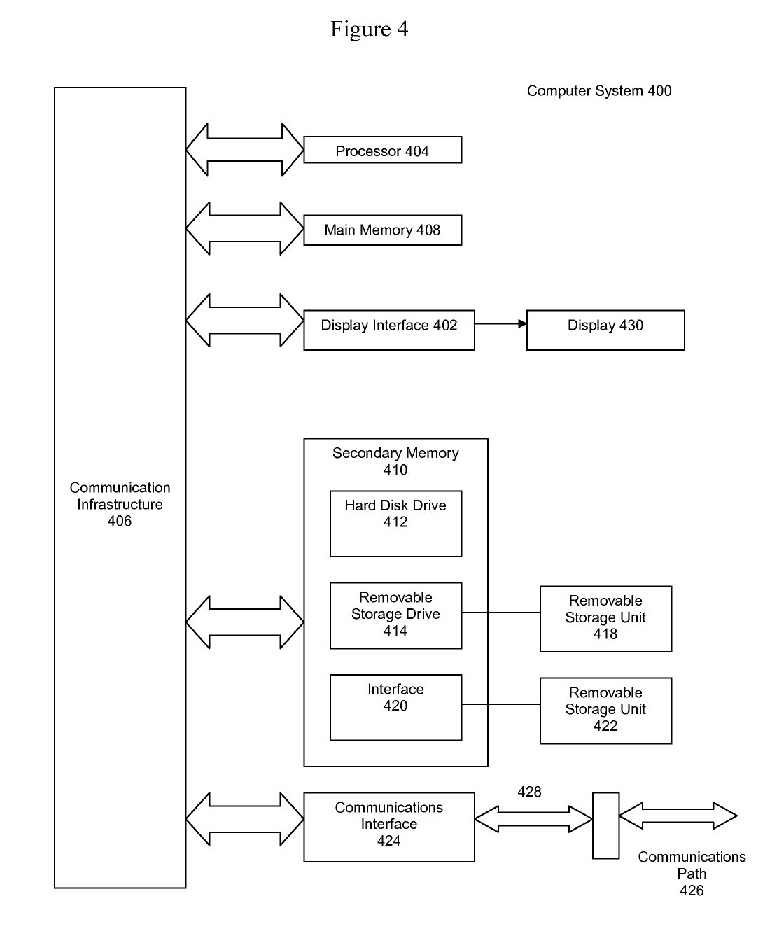

Communication between the various parties and components of the present invention may be accomplished over a network including electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 4, below.

Computer Implementation

In some embodiments, the present disclosure is directed toward one or more computer systems capable of carrying out the functionality described herein. For example, FIG. 4 is a schematic drawing of a computer system 400 used to implement the methods presented above. Computer system 400 includes one or more processors, such as processor 404. The processor 404 is connected to a communication infrastructure 406 (e.g., a communications bus, cross-over bar, or network). Computer system 400 can include a display interface 402 that forwards graphics, text, and other data from the communication infrastructure 406 (or from a frame buffer not shown) for display on a local or remote display unit 430.

Computer system 400 also includes a main memory 408, such as random access memory (RAM), and may also include a secondary memory 410. The secondary memory 410 may include, for example, a hard disk drive 412 and/or a removable storage drive 414, representing a floppy disk drive, a magnetic tape drive, an optical disk drive, flash memory device, etc. The removable storage drive 414 reads from and/or writes to a removable storage unit 418. Removable storage unit 418 represents a floppy disk, magnetic tape, optical disk, flash memory device, etc., which is read by and written to by removable storage drive 414. As will be appreciated, the removable storage unit 418 includes a computer usable storage medium having stored therein computer software, instructions, and/or data.

In some embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow computer software, instructions, and/or data to be transferred from the removable storage unit 422 to computer system 400.

Computer system 400 may also include a communications interface 424. Communications interface 424 allows computer software, instructions, and/or data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 414, removable storage units 418, 422, data transmitted via communications interface 424, and/or a hard disk installed in hard disk drive 412. These computer program products provide computer software, instructions, and/or data to computer system 400. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the presented methods. Accordingly, such computer programs represent controllers of the computer system 400. Where appropriate, the processor 404, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 400 using removable storage drive 414, interface 420, hard drive 412, communications interface 424, or equivalents thereof. The control logic (software), when executed by the processor 404, causes the processor 404 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments of the invention, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In some embodiments, machine readable medium is provided in a non-transitory form. Further, firmware, software, routines, and instructions may be described herein as performing certain actions. However, it should be appreciated that such descriptions are merely for convenience and that such actions in fact result from computing devices, processors, controllers, or other devices executing firmware, software, routines, instructions, etc.

In one embodiment, there is provided an article of manufacture including: a machine-readable medium having machine-readable instructions stored thereon, the instructions including: instructions for providing a user with a plurality of advertisements; instructions for identifying one or more advertisements selected by the user for display via a digital medium, e.g., on a webpage; instructions for providing the user with a plurality of customization options for the display of the one or more advertisements selected by the user for display via the digital medium; instructions for receiving one or more user selections for the customization options; and instructions for displaying via the digital medium the one or more advertisements selected by the user for display via the digital medium in accordance with the one or more user selections for the customization options.

In one embodiment, the computer system(s) may consist solely of “virtual” or “cloud” computer instances, e.g., Amazon® Web Services infrastructure.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-182 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below.
1. A method for user selection and customization of advertisements for display via a digital medium, the method including the following steps, one or more of which are performed using one or more computer processors:
   searching a database of advertisements;
   selecting for display via a digital medium one or more of the advertisements based on a result of the searching step;
   selecting a format for the display of the one or more advertisements selected for display via the digital medium;
   viewing a plurality of customization options for display of the one or more advertisements selected for display via the digital medium;
   selecting one or more of the customization options for display of the one or more advertisements selected for display via the digital medium; and
   viewing the one or more advertisements selected for display via the digital medium in accordance with the one or more selections for the one or more customization options.
2. The method of 1, wherein the digital medium includes a webpage.
3. The method of 2, wherein the webpage is selected from: a user profile page, a blog page, a webpage of a business entity, and a webpage of a non-profit organization.
4. The method of 3, wherein the webpage is a user profile page and the user profile page is a user profile page of a social networking website.
5. The method of any one of 1-4, including replacing one or more advertisements displayed via the digital medium with one or more additional advertisements.
6. The method of any one of 1-5, including adjusting the display parameters of one or more advertisements displayed via the digital medium.
7. The method of any one of 1-6, including utilizing a graphical user interface including drag-drop functionality for the selection of the one or more advertisements for display.
8. The method of any one of 1-7, including selecting for display via the digital medium one or more advertisements categorized by genre.
9. The method of any one of 1-8, wherein the display format is selected from an audio format, a video format, an image format, or a combination of two or more of the above formats.
10. The method of any one of 1-9, wherein the selecting one or more of the customization options for display of the one or more advertisements selected for display via the digital medium includes selecting a selectable size and/or shape of an advertisement window to be displayed via the digital medium, wherein an advertisement of the one or more advertisements is sized and/or shaped to fit a selected size and/or shape of the advertisement window upon display of the one or more advertisements via the digital medium.
11. The method of any one of 1-10, wherein the selecting one or more of the customization options for display of the one or more advertisements selected for display via the digital medium includes selecting photo filter effects and/or backgrounds which include an advertiser's logo and/or brand name.
12. The method of 11, wherein the photo filter effects and/or backgrounds include a hyperlink directed to a webpage of the advertiser.
13. The method any one of 1-12, wherein the selecting one or more of the customization options for display of the one or more advertisements selected for display via the digital medium includes selecting a duration and/or frequency of display of the one or more advertisements via the digital medium.
14. The method of any one of 1-13, wherein the selecting one or more of the customization options for display of the one or more advertisements selected for display via the digital medium includes selecting between a mobile device display configuration and a non-mobile device display configuration.
15. The method of any one of 1-14, wherein the digital medium includes a webpage, and wherein the method includes receiving compensation based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
16. The method of 15, wherein the compensation is monetary compensation.
17. The method of 15, wherein the compensation is in the form of one or more credits, coupons, discounts, promotions, raffles or special offers.
18. The method of any one of 1-14, wherein the digital medium includes a webpage, and wherein the method includes selecting to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
19. The method of 18, including selecting to donate to charity the earned compensation, and receiving, based on this selection, a charity badge, which is displayed on the webpage.
20. The method of 18, including selecting to not receive compensation, and receiving based on this selection, a badge, which is displayed on the webpage.
21. The method of any one of 1-20, including receiving recommended advertisements based on the user's prior selections of advertisements and/or the user's prior selections for the customization options.
22. The method of any one of 1-21, wherein the recommended advertisements are based on an analysis of the user's history of prior selections of advertisements and/or prior selections for the customization options.
23. The method of 21 or 22, including accepting, rejecting or modifying the recommended advertisements.
24. The method of 23, including receiving additional recommended advertisements based at least in part on the user's prior acceptance, rejection or modification of previously recommended advertisements.
25. The method of any one of 1-24, wherein the digital medium includes a webpage, and wherein the method includes receiving recommended advertisements based on one or more photo tags found on the webpage or associated with media uploaded, downloaded, and/or viewed by the user.
26. The method of any one of 1-25, including selecting a plurality of advertisements for display via a digital medium, wherein at least one of the plurality of advertisements selected for display is stored for access by the user at a later time.
27. The method of any one of 1-26, including receiving one or more replacement advertisements for the one or more advertisements selected for display via the digital medium from an ad queue including a plurality of replacement advertisements.
28. The method of 27, wherein the receiving one or more replacement advertisements occurs at expiration, following a predetermined time period and/or number of click-through events, or removal, of one or more of the one or more advertisements selected for display via the digital medium.
29. The method of 27 or 28, wherein the ad queue is populated with advertisements by the user.
30. The method of 27 or 28, wherein the ad queue is populated automatically.
31. A method for providing user-customized advertisements via a digital medium, the method including the following steps, one or more of which are performed using one or more computer processors:
   providing a user with a plurality of advertisements;
   identifying one or more advertisements selected by the user for display via a digital medium;
   providing the user with a plurality of customization options for the display of the one or more advertisements selected by the user for display via the digital medium;
   receiving one or more user selections for the customization options; and
   displaying via the digital medium the one or more advertisements selected by the user for display via the digital medium in accordance with the one or more user selections for the customization options.
32. The method of 31, wherein the digital medium includes a webpage.
33. The method of 32, wherein the webpage is selected from: a user profile page, a blog page, a webpage of a business entity, and a webpage of a non-profit organization.
34. The method of 33, wherein the webpage is a user profile page and the user profile page is a user profile page of a social networking website.
35. The method of any one of 31-34, including providing the user with the option to replace one or more advertisements displayed via the digital medium with one or more additional advertisements.
36. The method of any one of 31-35, including providing the user with the option to adjust the display parameters of one or more advertisements displayed via the digital medium.
37. The method of any one of 31-36, including providing the user with a graphical user interface including drag-drop functionality for the selection of the one or more advertisements for display.
38. The method of any one of 31-37, including providing the user with a graphical user interface including search functionality, wherein the search functionality allows the user to search a database of advertisements in order to identify one or more advertisements to be displayed via the digital medium.
39. The method of 38, wherein the graphical user interface prompts the user to select one or more advertisements categorized by genre.
40. The method of any one of 31-39, wherein the plurality of customization options for the display of the one or more advertisements via the digital medium includes a display format for one or more of the one or more advertisements, wherein the display format is selected from an audio format, a video format, an image format, or a combination of two or more of the above formats.
41. The method of any one of 31-40, wherein the plurality of customization options for the display of the one or more advertisements via the digital medium includes a selectable size and/or shape of an advertisement window to be displayed via the digital medium, wherein an advertisement of the one or more advertisements is sized and/or shaped to fit a selected size and/or shape of the advertisement window upon display of the one or more advertisements via the digital medium.
42. The method of any one of 31-41, wherein the plurality of customization options for the display of the one or more advertisements via the digital medium includes an option to select photo filter effects and/or backgrounds which include an advertiser's logo and/or brand name.
43. The method of 42, wherein the photo filter effects and/or backgrounds include a hyperlink directed to a webpage of the advertiser.
44. The method of any one of 31-43, wherein the plurality of customization options for the display of the one or more advertisements via the digital medium includes a duration and/or frequency of display of the one or more advertisements via the digital medium.
45. The method any one of 31-44, wherein the plurality of customization options for display of the one or more advertisements selected for display via the digital medium includes an option to select a mobile device display configuration or a non-mobile device display configuration.
46. The method of any one of 31-45, wherein display of one or more of the one or more advertisements displayed via the digital medium terminates following a predetermined time period and/or number of click-through events.
47. The method of 46, including prompting the user to select one or more replacement advertisements to replace the one or more advertisements for which display terminates following the predetermined time period and/or number of click-through events.
48. The method of 46, including automatically replacing, without user input, the one or more advertisements for which display terminates following the predetermined time period and/or number of click-through events.
49. The method any one of 31-48, wherein the digital medium includes a webpage, and wherein the method includes providing compensation to the user based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
50. The method of 49, wherein the compensation is monetary compensation.
51. The method of 49, wherein the compensation is in the form of one or more credits, coupons, discounts, promotions, raffles or special offers.
52. The method of any one of 31-48, wherein the digital medium includes a website, and wherein the method includes receiving a user's selection to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
53. The method of 52, including displaying on the webpage a charity badge based on the user's selection to donate to charity the earned compensation.
54. The method of 52, including displaying on the webpage a badge based on the user's selection to not receive the earned compensation.
55. The method of any one of 31-54, including providing recommended advertisements to the user based on the user's prior selections of advertisements and/or the user's prior selections for the customization options.
56. The method of 55, wherein the recommended advertisements are based on an analysis of the user's history of prior selections of advertisements and/or prior selections for the customization options.
57. The method of 55 or 56, including receiving from the user an acceptance, rejection or modification of the recommended advertisements.
58. The method of 57, including providing additional recommended advertisements based at least in part on the user's prior acceptance, rejection or modification of previously recommended advertisements.
59. The method of any one of 31-58, wherein the digital medium includes a webpage, and wherein the method includes providing recommended advertisements to the user based on one or more photo tags found on the webpage or associated with media uploaded, downloaded, and/or viewed by the user.
60. The method of any one of 31-59, including storing at least one of a plurality of advertisements selected by the user for display via a digital medium for access by the user at a later time.
61. The method of any one of 31-60, including providing the user with one or more replacement advertisements for the one or more advertisements selected for display via the digital medium from an ad queue including a plurality of replacement advertisements.
62. The method of 61, wherein the providing the user with one or more replacement advertisements occurs at expiration, following a predetermined time period and/or number of click-through events, or removal, of one or more of the one or more advertisements selected for display via the digital medium.
63. The method of 61 or 62, wherein the ad queue is populated with advertisements by the user.
64. The method of 61 or 62, wherein the ad queue is populated automatically.
65. A system for providing user-customized advertisements via a digital medium, the system including:
   an advertisement database;
   a user device displaying a digital medium;
   one or more computer processors; and
   a graphical user interface, wherein the graphical user interface
      provides for selection by the user of one or more advertisements from the advertisement database to be displayed via the digital medium, and
      provides the user with a plurality of customization options for the display of the one or more advertisements via the digital medium, and
      wherein one or more of the one or more processors receives one or more user selections for the customization options and displays via the digital medium the one or more advertisements selected by the user for display via the digital medium in accordance with the one or more user selections for the customization options.
66. The system of 65, wherein the digital medium includes a webpage.
67. The system of 66, wherein the webpage is selected from: a user profile page, a blog page, a webpage of a business entity, and a webpage of a non-profit organization.
68. The system of 67, wherein the webpage is a user profile page and the user profile page is a user profile page of a social networking website.
69. The system of any one of 65-68, wherein the graphical user interface provides the user with the option to replace one or more of the advertisements displayed via the digital medium with one or more additional advertisements.
70. The system of any one of 65-69, wherein the graphical user interface provides the user with the option to adjust the display parameters of one or more advertisements displayed via the digital medium.
71. The system of any one of 65-70, wherein the graphical user interface includes drag-drop functionality for the selection of the one or more advertisements for display.
72. The system of any one of 65-71, wherein the graphical user interface includes search functionality, wherein the search functionality allows the user to search the advertisement database in order to identify one or more advertisements to be displayed via the digital medium.
73. The system of 72, wherein the graphical user interface prompts the user to select one or more advertisements categorized by genre.
74. The system of any one of 65-73, wherein the plurality of customization options for the display of the one or more advertisements via the digital medium includes a display format for one or more of the one or more advertisements, wherein the display format is selected from an audio format, a video format, an image format, or a combination of two or more of the above formats.
75. The system of any one of 65-74, wherein the plurality of customization options for the display of the one or more advertisements via the digital medium includes a selectable size and/or shape of an advertisement window to be displayed via the digital medium, wherein an advertisement of the one or more advertisements is sized and/or shaped to fit a selected size and/or shape of the advertisement window upon display of the one or more advertisements via the digital medium.
76. The system of any one of 65-75, wherein the plurality of customization options for the display of the one or more advertisements via the digital medium includes an option to select photo filter effects and/or backgrounds which include an advertiser's logo and/or brand name.
77. The system of 76, wherein the photo filter effects and/or backgrounds include a hyperlink directed to a webpage of the advertiser.
78. The system of any one of 65-77, wherein the plurality of customization options for the display of the one or more advertisements via the digital medium includes a duration and/or frequency of display of the one or more advertisements via the digital medium.
79. The system of any one of 65-78, wherein the plurality of customization options for display of the one or more advertisements selected for display via the digital medium includes an option to select a mobile device display configuration or a non-mobile device display configuration.
80. The system of any one of 65-79, wherein display of one or more of the one or more advertisements displayed via the digital medium terminates following a predetermined time period and/or number of click-through events.
81. The system of 80, wherein the graphical user interface prompts the user to select one or more replacement advertisements to replace the one or more advertisements for which display terminates following the predetermined time period and/or number of click-through events.
82. The system of 80, wherein the one or more computer processors automatically replaces, without user input, the one or more advertisements for which display terminates following the predetermined time period and/or number of click-through events.
83. The system of any one of 65-82, wherein the digital medium includes a webpage, and wherein one or more of the one or more processors monitors one or more of the following in order to provide compensation to the user based thereon: the number of views the webpage receives, the number of views the webpage receives within a given time period, the number of click-through events an advertisement displayed via the webpage receives, the number of click-through events an advertisement displayed via the webpage receives in a given time period, the number of users linked to the webpage, and the number of users who access the webpage in a given time period.
84. The system of 83, wherein the compensation is monetary compensation.
85. The system of 83, wherein the compensation is in the form of one or more credits, coupons, discounts, promotions, raffles or special offers.
86. The system of any one of 65-82, wherein the digital medium includes a webpage, and wherein one or more of the one or more processors receives a user's selection to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
87. The system of 86, wherein one or more of the one or more processors displays on the webpage a charity badge based on the user's selection to donate to charity the earned compensation.
88. The system of 86, wherein one or more of the one or more processors displays on the webpage a badge based on the user's selection to not receive the earned compensation.
89. The system of any one of 65-88, wherein one or more of the one or more processors provide recommended advertisements to the user via the graphical user interface based on the user's prior selections of advertisements and/or the user's prior selections for the customization options.
90. The system of 89, wherein the recommended advertisements are based on an analysis of the user's history of prior selections of advertisements and/or prior selections for the customization options.
91. The system of 89 or 90, wherein one or more of the one or more processors receives from the user an acceptance, rejection or modification of the recommended advertisements.
92. The system of 91, wherein one or more of the one or more processors provides additional recommended advertisements based at least in part on the user's prior acceptance, rejection or modification of previously recommended advertisements.
93. The system of any one of 65-92, wherein the digital medium includes a webpage, and wherein one or more of the one or more processors provide recommended advertisements to the user via the graphical user interface based on one or more photo tags found on the webpage or associated with media uploaded, downloaded, and/or viewed by the user.
94. The system of any one of 65-93, including memory storing at least one of a plurality of advertisements selected by the user for display via a digital medium for access by the user at a later time.
95. The system any one of 65-94, wherein one or more of the one or more processors provides the user with one or more replacement advertisements for one or more advertisements selected for display via the digital medium from an ad queue including a plurality of replacement advertisements.
96. The system of 95, wherein one or more of the one or more processors provides the user with one or more replacement advertisements at expiration, following a predetermined time period and/or number of click-through events, or removal, of one or more of the one or more advertisements selected for display via the digital medium.
97. The system of 95 or 96, wherein the ad queue is populated with advertisements by the user via the graphical user interface.
98. The system of 95 or 96, wherein the ad queue is populated automatically by one or more of the one or more processors.
99. A system including:
   an ad search module including a graphical user interface, wherein the ad search module provides a user of the system with one or more advertisements; and
   an ad manager module including a graphical user interface, wherein the ad manager module:
      receives one or more user-selected advertisements from the ad search module,
      provides the user with a plurality of customization options for display of the one or more user-selected advertisements via a digital medium,
      receives one or more user selections for the customization options, and
      displays via the digital medium the one or more user-selected advertisements in accordance with the one or more user selections for the customization options.
100. The system of 99, wherein the digital medium includes a webpage.
101. The system of 100, wherein the webpage is selected from: a user profile page, a blog page, a webpage of a business entity, and a webpage of a non-profit organization.
102. The system of 101, wherein the webpage is a user profile page and the user profile page is a user profile page of a social networking website.
103. The system of any one of 99-102, wherein the ad manager module provides the user with the option to replace one or more user-selected advertisements displayed via the digital medium with one or more additional user-selected advertisements.
104. The system of any one of 99-102, wherein the ad manager module provides the user with the option to adjust the display parameters of one or more user-selected advertisements displayed via the digital medium.
105. The system of any one of 99-104, wherein the ad search module provides a search feature which allows a user to search a database of advertisements to identify one or more advertisements meeting selected search criteria.
106. The system of 105, wherein the ad search module provides the user of the system with the one or more advertisements in response to the user executing a search using the search feature.
107. The system of 106, wherein the ad search module provides the user of the system with the one or more advertisements in a tile format in response to the user executing a search using the search feature.
108. The system of 106 or 107, wherein the ad search module includes drag-drop functionality which allows the user to select one or more of the one or more advertisements for viewing and/or modification using the ad manager module.
109. The system of any one of 99-108, wherein the ad search module prompts the user to select a genre of advertisements.
110. The system of any one of 99-109, wherein the ad search module provides the user with an alphabetical directory of advertisements.
111. The system of any one of 99-110, wherein the ad search module prompts the user to select a display format for the one or more advertisements, wherein the display format is selected from an audio format, a video format, an image format, or a combination of two or more of the above formats.
112. The system of any one of 99-111, wherein ad manager module displays on a preview page the one or more user-selected advertisements in accordance with the one or more user selections for the customization options prior to displaying the one or more advertisements via the digital medium.
113. The system of any one of 99-112, wherein the plurality of customization options for the display of the one or more user-selected advertisements via the digital medium includes a selectable size and/or shape of an advertisement window to be displayed via the digital medium, wherein a user-selected advertisement of the one or more user-selected advertisements is sized and/or shaped to fit a selected size and/or shape of the advertisement window upon display of the one or more user-selected advertisements via the digital medium.
114. The system of any one of 99-113, wherein the plurality of customization options for the display of the one or more user-selected advertisements via the digital medium includes an option to select photo filter effects and/or backgrounds which include an advertiser's logo and/or brand name.
115. The system of 114, wherein the photo filter effects and/or backgrounds include a hyperlink directed to a webpage of the advertiser.
116. The system of any one of 99-115, wherein the ad manager module provides the user with the option to share one or more user-selected advertisements with one or more additional users.
117. The system of any one of 99-116, including an ad recommendation engine, wherein the ad recommendation engine provides recommended advertisements to the user based on the user's prior selections of user selectable advertisements and/or the user's prior selections for the customization options.
118. The system of 117, wherein the recommended advertisements are based on an analysis of the user's history of prior selections of user selectable advertisements and/or the user's prior selections for the customization options.
119. The system of 117 or 118, wherein the ad recommendation engine receives from the user an acceptance, rejection or modification of the recommended advertisements.
120. The system of 119, wherein the ad recommendation engine provides additional recommended advertisements based at least in part on the user's prior acceptance, rejection or modification of previously recommended advertisements.
121. The system of any one of 99-120, wherein the digital medium includes a webpage, and the system includes an ad recommendation engine, wherein the ad recommendation engine provides recommended advertisements to the user based on one or more photo tags found on the webpage or associated with media uploaded, downloaded, and/or viewed by the user.
122. The system of any one of 99-121, wherein the plurality of customization options for the display of the one or more user-selected advertisements via the digital medium includes a duration and/or frequency of display of the one or more user-selected advertisements via the digital medium.
123. The system of any one of 99-122, wherein the plurality of customization options for the display of the one or more user-selected advertisements via the digital medium includes an option to select a mobile device display configuration or a non-mobile device display configuration.
124. The system of any one of 99-123, wherein display of one or more of the one or more user-selected advertisements displayed via the digital medium terminates following a predetermined time period and/or number of click-through events.
125. The system of 124, wherein the ad search module and/or the ad manager module prompts the user to select one or more replacement advertisements to replace the one or more advertisements for which display terminates following the predetermined time period and/or number of click-through events.
126. The system of 124, wherein the ad search module and/or the ad manager module automatically replaces, without user input, the one or more advertisements for which display terminates following the predetermined time period and/or number of click-through events.
127. The system of any one of 99-126, wherein the digital medium includes a webpage, and wherein the system includes one or more processors, wherein the one or more processors monitor one or more of the following in order to provide compensation to the user based thereon: the number of views the webpage receives, the number of views the webpage receives within a given time period, the number of click-through events a user-selected advertisement displayed via the webpage receives, the number of click-through events a user-selected advertisement displayed via the webpage receives in a given time period, the number of users linked to the webpage, and the number of users who access the webpage in a given time period.
128. The system of 127, wherein the compensation is monetary compensation.
129. The system of 127, wherein the compensation is in the form of one or more credits, coupons, discounts, promotions, raffles or special offers.
130. The system of any one of 99-126, wherein the digital medium includes a webpage, and wherein the ad manager module receives a user's selection to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
131. The system of 130, wherein the ad manager module displays on the webpage a charity badge based on the user's selection to donate to charity the earned compensation.
132. The system of 130, wherein the ad manager module displays on the webpage a badge based on the user's selection to not receive the earned compensation.
133. The system of any one of 99-132, wherein the ad search module and/or the ad manager module includes memory storing at least one of a plurality of advertisements selected by the user for display via a digital medium for access by the user at a later time.
134. The system of any one of 99-133, wherein the ad search module and/or the ad manager module provides the user with one or more replacement advertisements for one or more of the one or more user-selected advertisements from an ad queue including a plurality of replacement advertisements.
135. The system of 134, wherein the ad search module and/or the ad manager module provides the user with one or more replacement advertisements at expiration, following a predetermined time period and/or number of click-through events, or removal, of one or more of the one or more user-selected advertisements.
136. The system of 134 or 135, wherein the ad queue is populated with advertisements by the user via the ad search module and/or the ad manager module.
137. The system of 134 or 135, wherein the ad queue is populated automatically by the ad search module and/or the ad manager module.
138. An article of manufacture including:
   a machine-readable medium having machine-readable instructions stored thereon, the instructions including:
   instructions for providing a user with a plurality of advertisements;
   instructions for identifying one or more advertisements selected by the user for display via a digital medium;
   instructions for providing the user with a plurality of customization options for the display of the one or more advertisements selected by the user for display via the digital medium;
   instructions for receiving one or more user selections for the customization options; and
   instructions for displaying via the digital medium the one or more advertisements selected by the user for display via the digital medium in accordance with the one or more user selections for the customization options.
139. The article of manufacture of 138, wherein the digital medium includes a webpage.
140. The article of manufacture of 139, wherein the webpage is selected from: a user profile page, a blog page, a webpage of a business entity, and a webpage of a non-profit organization.
141. The article of manufacture of 140, wherein the webpage is a user profile page and the user profile page is a user profile page of a social networking website.
142. The article of manufacture of any one of 138-141, wherein the machine-readable instructions include instructions for providing the user with the option to replace one or more advertisements displayed via the digital medium with one or more additional advertisements.
143. The article of manufacture of any one of 138-142, wherein the machine-readable instructions include instructions for providing the user with the option to adjust the display parameters of one or more advertisements displayed via the digital medium.
144. The article of manufacture of any one of 138-143, wherein the machine-readable instructions include instructions for providing the user with a graphical user interface including drag-drop functionality for the selection of the one or more advertisements for display.
145. The article of manufacture any one of 138-144, wherein the machine-readable instructions include instructions for providing the user with a graphical user interface including search functionality, wherein the search functionality allows the user to search a database of advertisements in order to identify one or more advertisements to be displayed via the digital medium.
146. The article of manufacture of 145, wherein the graphical user interface prompts the user to select one or more advertisements categorized by genre.
147. The article of manufacture of any one of 138-146, wherein the plurality of customization options for the display of the one or more advertisements via the digital medium includes a display format for one or more of the one or more advertisements, wherein the display format is selected from an audio format, a video format, an image format, or a combination of two or more of the above formats.
148. The article of manufacture of any one of 138-147, wherein the plurality of customization options for the display of the one or more advertisements via the digital medium includes a selectable size and/or shape of an advertisement window to be displayed via the digital medium, wherein an advertisement of the one or more advertisements is sized and/or shaped to fit a selected size and/or shape of the advertisement window upon display of the one or more advertisements via the digital medium.
149. The article of manufacture of any one of 138-149, wherein the plurality of customization options for the display of the one or more advertisements via the digital medium includes an option to select photo filter effects and/or backgrounds which include an advertiser's logo and/or brand name.
150. The article of manufacture of 149, wherein the photo filter effects and/or backgrounds include a hyperlink directed to a webpage of the advertiser.
151. The article of manufacture of any one of 138-150, wherein the plurality of customization options for the display of the one or more advertisements via the digital medium includes a duration and/or frequency of display of the one or more advertisements via the digital medium.
152. The article of manufacture of any one of 138-151, wherein the plurality of customization options for display of the one or more advertisements selected for display via the digital medium includes an option to select a mobile device display configuration or a non-mobile device display configuration.
153. The article of manufacture of any one of 138-152, wherein display of one or more of the one or more advertisements displayed via the digital medium terminates following a predetermined time period and/or number of click-through events.
154. The article of manufacture of 153, wherein the machine-readable instructions include instructions for prompting the user to select one or more replacement advertisements to replace the one or more advertisements for which display terminates following the predetermined time period and/or number of click-through events.
155. The article of manufacture of 153, wherein the machine-readable instructions include instructions for automatically replacing, without user input, the one or more advertisements for which display terminates following the predetermined time period and/or number of click-through events.
156. The article of manufacture of any one of 138-155, wherein the digital medium includes a webpage, and wherein the article of manufacture includes instructions for providing compensation to the user based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
157. The article of manufacture of 156, wherein the compensation is monetary compensation.
158. The article of manufacture of 156, wherein the compensation is in the form of one or more credits, coupons, discounts, promotions, raffles or special offers.
159. The article of manufacture of any one of 138-155, wherein the digital medium includes a webpage, and wherein the article of manufacture includes instructions for receiving a user's selection to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.
160. The article of manufacture of 159, wherein the machine-readable instructions include instructions for displaying on the webpage a charity badge based on the user's selection to donate to charity the earned compensation.
161. The article of manufacture of 159, wherein the machine-readable instructions include instructions for displaying on the webpage a badge based on the user's selection to not receive the earned compensation.
162. The article of manufacture of any one of 138-161, wherein the machine-readable instructions include instructions for providing recommended advertisements to the user based on the user's prior selections of advertisements and/or the user's prior selections for the customization options.
163. The article of manufacture of 162, wherein the recommended advertisements are based on an analysis of the user's history of prior selections of advertisements and/or prior selections for the customization options.
164. The article of manufacture of 162 or 163, wherein the machine-readable instructions include instructions for receiving from the user an acceptance, rejection or modification of the recommended advertisements.
165. The article of manufacture of 164, wherein the machine-readable instructions include instructions for providing additional recommended advertisements based at least in part on the user's prior acceptance, rejection or modification of previously recommended advertisements.
166. The article of manufacture of any one of 138-165, wherein the digital medium includes a webpage, and wherein the article of manufacture includes instructions for providing recommended advertisements to the user based on one or more photo tags found on the webpage or associated with media uploaded, downloaded, and/or viewed by the user.
167. The article of manufacture of any one of 138-166, wherein the machine-readable instructions include instructions for storing at least one of a plurality of advertisements selected by the user for display via a digital medium for access by the user at a later time.
168. The article of manufacture of any one of 138-167, wherein the machine-readable instructions include instructions for providing the user with one or more replacement advertisements for the one or more advertisements selected for display via the digital medium from an ad queue including a plurality of replacement advertisements.
169. The article of manufacture of 168, wherein the providing the user with one or more replacement advertisements occurs at expiration, following a predetermined time period and/or number of click-through events, or removal, of one or more of the one or more advertisements selected for display via the digital medium.
170. The article of manufacture of 168 or 169, wherein the ad queue is populated with advertisements by the user.
171. The article of manufacture of 168 or 169, wherein the ad queue is populated automatically.
172. A method including:
   receiving for display at a graphical user interface one or more first metrics characterizing the performance level of a user of a social networking service with respect to the display or distribution of one or more first advertisements via the social networking service;
   providing one or more second advertisements to a database accessible by the user via the social networking service if the user is determined to have met a specified performance level with respect to the display or distribution of the one or more first advertisements; and
   periodically monitoring one or more second metrics characterizing the performance of the user with respect to the display or distribution of the one or more second advertisements via the social networking service.
173. The method of 172, wherein the one or more first metrics are selected from: the number of views a user webpage on the social networking service displaying the first advertisement receives, the number of views the user webpage receives within a given time period, the number of click-through events the first advertisement displayed on the user webpage receives, the number of click-through events the first advertisement displayed on the user webpage receives in a given time period, the number of users that receive the first advertisement from the user, and the number of users that view the first advertisement received from the user.
174. The method of 172 or 173, wherein the one or more second metrics are selected from: the number of views a user webpage on the social networking service displaying the second advertisement receives, the number of views the user webpage receives within a given time period, the number of click-through events the second advertisement displayed on the user webpage receives, the number of click-through events the second advertisement displayed on the user webpage receives in a given time period, the number of users that receive the second advertisement from the user, and the number of users that view the second advertisement received from the user.
175. A method including:
   receiving for display at a graphical user interface a relevancy ranking characterizing the relevance of each of a plurality users of a social networking service with respect to the proposed display or distribution of one or more merchant advertisements via the social networking service;
   selecting, based on the relevancy ranking, one or more users from the plurality of users;
   providing one or more advertisements to a database accessible by the selected user via the social networking service, such that the user can select the one or more advertisements for display or distribution via the social networking service; and
   periodically monitoring metrics characterizing the performance of the user with respect to the display or distribution of the one or more advertisements via the social networking service.
176. The method of 175, wherein the relevance ranking is based at least in part on the geographical location of the user and the merchant.
177. The method of 175 or 176, wherein the relevance ranking is based at least in part on the number of views a user webpage on the social networking service receives, the number of views the user webpage receives within a given time period, and the numbers of users linked to the user webpage.
178. The method of 175-177, wherein the relevance ranking is based at least in part on the content of one or more of the user's posts on the social networking service
179. A method including:
   receiving for display at a graphical user interface one or more metrics characterizing the performance level of a user of a social networking service with respect to the display or distribution of one or more first advertisements via the social networking service; and
   receiving one or more second advertisements from a database accessible by the user via the social networking service if the user is determined to have met a specified performance level with respect to the display or distribution of the one or more first advertisements.
180. The method of 179, wherein the one or more metrics are selected from: the number of views a user webpage on the social networking service displaying the first advertisement receives, the number of views the user webpage receives within a given time period, the number of click-through events the first advertisement displayed on the user webpage receives, the number of click-through events the first advertisement displayed on the user webpage receives in a given time period, and the number of users that view the first advertisement received from the user.
181. A method for providing user-customized advertisements, the method comprising the following steps, one or more of which are performed using one or more computer processors:
   providing a user with a plurality of advertisements via a graphical user interface;
   identifying one or more advertisements selected by the user for display via one or more forms of media;
   providing the user with a plurality of customization options, via the graphical user interface, for the display of the one or more advertisements selected by the user;
   receiving one or more user selections, via the graphical user interface, for the customization options; and
displaying (or causing to be displayed, e.g., providing instructions to display), via the one or more forms of media, the one or more advertisements selected by the user for display in accordance with the one or more user selections for the customization options.
182. The method of 181, wherein the displaying includes displaying the one or more advertisements via one or more of the following display devices: a billboard (e.g., an electronic billboard), an in-store display (e.g., an in-store electronic display), a television, a personal computer, a mobile device (e.g., a tablet computer, e-reader, mobile phone, wearable computing device (e.g., smart watch), etc.), a theater screen, an in-vehicle entertainment system, etc.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Accordingly, it is to be understood that this invention is not limited to particular embodiments described, and as such may vary. It is also to be understood that the terminology used herein is for the purpose of describing particular embodiments only, and is not intended to be limiting.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Further, each system component and/or method step presented should be considered a “means for” or “step for” performing the function described for said system component and/or method step. As such, any claim language directed to a “means for” or “step for” performing a recited function refers to the system component and/or method step in the specification that performs the recited function, as well as equivalents thereof.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method for providing user-customized advertisements via a digital medium, the method comprising the following steps, one or more of which are performed using one or more computer processors:
providing a user with a plurality of advertisements via a graphical user interface;
identifying one or more advertisements selected by the user for display via a digital medium;
providing the user with a plurality of customization options, via the graphical user interface, for the display of the one or more advertisements selected by the user for display via the digital medium;
receiving one or more user selections for the customization options; and
displaying via the digital medium the one or more advertisements selected by the user for display via the digital medium in accordance with the one or more user selections for the customization options.

2. The method of claim 1, wherein the digital medium comprises a webpage.

3. The method of claim 2, wherein the webpage is selected from: a user profile page, a blog page, a webpage of a business entity, and a webpage of a non-profit organization.

4. The method of claim 3, wherein the webpage is a user profile page and the user profile page is a user profile page of a social networking website.

5. The method of claim 1, comprising providing the user with the option to replace one or more advertisements displayed via the digital medium with one or more additional advertisements.

6. The method of claim 1, comprising providing the user with the option to adjust the display parameters of one or more advertisements displayed via the digital medium.

7. The method of claim 1, comprising providing the user with a graphical user interface comprising drag-drop functionality for the selection of the one or more advertisements for display.

8. The method of claim 1, comprising providing the user with a graphical user interface comprising search functionality, wherein the search functionality allows the user to search a database of advertisements in order to identify one or more advertisements to be displayed via the digital medium.

9. The method of claim 8, wherein the graphical user interface prompts the user to select one or more advertisements categorized by genre.

10. The method of claim 1, wherein the plurality of customization options for the display of the one or more advertisements via the digital medium comprises a display format for one or more of the one or more advertisements, wherein the display format is selected from an audio format, a video format, an image format, or a combination of two or more of the above formats.

11. The method of claim 1, wherein the plurality of customization options for the display of the one or more advertisements via the digital medium comprises a selectable size and/or shape of an advertisement window to be displayed via the digital medium, wherein an advertisement of the one or more advertisements is sized and/or shaped to fit a selected size and/or shape of the advertisement window upon display of the one or more advertisements via the digital medium.

12. The method of claim 1, wherein the plurality of customization options for the display of the one or more advertisements via the digital medium comprises an option to select photo filter effects and/or backgrounds which include an advertiser's logo and/or brand name.

13. The method of claim 12, wherein the photo filter effects and/or backgrounds comprise a hyperlink directed to a webpage of the advertiser.

14. The method of claim 1, wherein the plurality of customization options for the display of the one or more advertisements via the digital medium comprises a duration and/or frequency of display of the one or more advertisements via the digital medium.

15. The method of claim 1, wherein the plurality of customization options for display of the one or more advertisements selected for display via the digital medium comprises an option to select a mobile device display configuration or a non-mobile device display configuration.

16. The method of claim 1, wherein display of one or more of the one or more advertisements displayed via the digital medium terminates following a predetermined time period and/or number of click-through events.

17. The method of claim 16, comprising prompting the user to select one or more replacement advertisements to replace the one or more advertisements for which display terminates following the predetermined time period and/or number of click-through events.

18. The method of claim 16, comprising automatically replacing, without user input, the one or more advertisements for which display terminates following the predetermined time period and/or number of click-through events.

19. The method of claim 1, wherein the digital medium comprises a webpage, and wherein the method comprises providing compensation to the user based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.

20. The method of claim 19, wherein the compensation is monetary compensation.

21. The method of claim 19, wherein the compensation is in the form of one or more credits, coupons, discounts, promotions, raffles or special offers.

22. The method of claim 1, wherein the digital medium comprises a website, and wherein the method comprises receiving a user's selection to receive, not receive, or donate to charity compensation earned based on one or more of the following: the number of views the webpage receives, the number of views the webpage receives within a given time period, the number of views an advertisement displayed via the webpage receives, the number of views an advertisement displayed via the webpage receives in a given time period, the number of click-through events an advertisement displayed via the webpage receives, the number of click-through events an advertisement displayed via the webpage receives in a given time period, the number of users linked to the webpage, and the number of users who access the webpage in a given time period.

23. The method of claim 22, comprising displaying on the webpage a charity badge based on the user's selection to donate to charity the earned compensation.

24. The method of claim 22, comprising displaying on the webpage a badge based on the user's selection to not receive the earned compensation.

25. The method of claim 1, comprising providing recommended advertisements to the user based on the user's prior selections of advertisements and/or the user's prior selections for the customization options.

26. The method of claim 25, wherein the recommended advertisements are based on an analysis of the user's history of prior selections of advertisements and/or prior selections for the customization options.

27. The method of claim 25, comprising receiving from the user an acceptance, rejection or modification of the recommended advertisements.

28. The method of claim 27, comprising providing additional recommended advertisements based at least in part on the user's prior acceptance, rejection or modification of previously recommended advertisements.

29. The method of claim 1, wherein the digital medium comprises a webpage, and wherein the method comprises providing recommended advertisements to the user based on one or more photo tags found on the webpage or associated with media uploaded, downloaded, and/or viewed by the user.

30. The method of claim 1, comprising storing at least one of a plurality of advertisements selected by the user for display via a digital medium for access by the user at a later time.

31. The method of claim 1, comprising providing the user with one or more replacement advertisements for the one or more advertisements selected for display via the digital medium from an ad queue comprising a plurality of replacement advertisements.

32. The method of claim 31, wherein the providing the user with one or more replacement advertisements occurs at expiration, following a predetermined time period and/or number of click-through events, or removal, of one or more of the one or more advertisements selected for display via the digital medium.

33. The method of claim 31, wherein the ad queue is populated with advertisements by the user.

34. The method of claim 31, wherein the ad queue is populated automatically.

35. A system for providing user-customized advertisements via a digital medium, the system comprising:
an advertisement database;
a user device displaying a digital medium;
one or more computer processors; and
a graphical user interface, wherein the graphical user interface
provides for selection by the user of one or more advertisements from the advertisement database to be displayed via the digital medium, and
provides the user with a plurality of customization options for the display of the one or more advertisements via the digital medium, and
wherein one or more of the one or more processors receives one or more user selections for the customization options and displays via the digital medium the one or more advertisements selected by the user for display via the digital medium in accordance with the one or more user selections for the customization options.

36. A system comprising:
an ad search module comprising a graphical user interface, wherein the ad search module provides a user of the system with one or more advertisements; and
an ad manager module comprising a graphical user interface, wherein the ad manager module:
receives one or more user-selected advertisements from the ad search module,
provides the user with a plurality of customization options for display of the one or more user-selected advertisements via a digital medium,
receives one or more user selections for the customization options, and
displays via the digital medium the one or more user-selected advertisements in accordance with the one or more user selections for the customization options.

37. An article of manufacture comprising:
a machine-readable medium having machine-readable instructions stored thereon, the instructions comprising:
instructions for providing a user with a plurality of advertisements;
instructions for identifying one or more advertisements selected by the user for display via a digital medium;
instructions for providing the user with a plurality of customization options for the display of the one or more advertisements selected by the user for display via the digital medium;
instructions for receiving one or more user selections for the customization options; and
instructions for displaying via the digital medium the one or more advertisements selected by the user for display via the digital medium in accordance with the one or more user selections for the customization options.

38. A method comprising:
receiving for display at a graphical user interface one or more first metrics characterizing the performance level of a user of a social networking service with respect to the display or distribution of one or more first advertisements via the social networking service;
providing one or more second advertisements to a database accessible by the user via the social networking service if the user is determined to have met a specified performance level with respect to the display or distribution of the one or more first advertisements; and
periodically monitoring one or more second metrics characterizing the performance of the user with respect to the display or distribution of the one or more second advertisements via the social networking service.

39. A method comprising:
receiving for display at a graphical user interface a relevancy ranking characterizing the relevance of each of a plurality users of a social networking service with respect to the proposed display or distribution of one or more merchant advertisements via the social networking service;
selecting, based on the relevancy ranking, one or more users from the plurality of users;
providing one or more advertisements to a database accessible by the selected user via the social networking service, such that the user can select the one or more advertisements for display or distribution via the social networking service; and
periodically monitoring metrics characterizing the performance of the user with respect to the display or distribution of the one or more advertisements via the social networking service.

40. A method comprising:
receiving for display at a graphical user interface one or more metrics characterizing the performance level of a user of a social networking service with respect to the display or distribution of one or more first advertisements via the social networking service; and
receiving one or more second advertisements from a database accessible by the user via the social networking service if the user is determined to have met a specified performance level with respect to the display or distribution of the one or more first advertisements.

41. The method of claim 40, wherein the one or more metrics are selected from: the number of views a user webpage on the social networking service displaying the first advertisement receives, the number of views the user webpage receives within a given time period, the number of click-through events the first advertisement displayed on the user webpage receives, the number of click-through events the first advertisement displayed on the user webpage receives in a given time period, and the number of users that view the first advertisement received from the user.

42. A method for providing user-customized advertisements, the method comprising the following steps, one or more of which are performed using one or more computer processors:
providing a user with a plurality of advertisements via a graphical user interface;
identifying one or more advertisements selected by the user for display via one or more forms of media;
providing the user with a plurality of customization options, via the graphical user interface, for the display of the one or more advertisements selected by the user;
receiving one or more user selections, via the graphical user interface, for the customization options; and
displaying, via the one or more forms of media, the one or more advertisements selected by the user for display in accordance with the one or more user selections for the customization options.
